(19) United States
(12) Patent Application Publication
(10) Pub. No.: US 2010/0282679 A1
(43) Pub. Date: Nov. 11, 2010

(54) ADVANCED CONTROL METHOD FOR A MEMBRANE FILTRATION UNIT, AND DEVICE FOR IMPLEMENTING THE METHOD

(75) Inventor: Chrystelle Langlais, Le Pecq (FR)

Correspondence Address: CONNOLLY BOVE LODGE & HUTZ LLP, 1875 EYE STREET, N.W., SUITE 1100, WASHINGTON, DC, 20006, US

(73) Assignee: Degremont, Rueil-Malmaison (FR)

(21) Appl. No.: 12/738,495

(22) PCT Filed: Oct. 14, 2008
(86) PCT No.: PCT/FR08/01438

§ 371 Date: Jul. 2, 2010

(30) Foreign Application Priority Data
Oct. 19, 2007 (FR) 0707323

(51) Int. Cl. B01D 61/22; B01D 61/18; B01D 61/20; B01D 65/08; C02F 1/44; C02F 1/52

(52) U.S. Cl. 210/639; 210/96.2; 210/143; 210/149; 210/105

(57) ABSTRACT

Advanced control method for a membrane filtration unit, applied to the treatment of an effluent, employing microcoagulation on a membrane, which consists in injecting, upstream of the membrane, a dose of coagulation reactant(s) 30 to 80 times below the dose (X) making the zeta potential of the effluent zero, in which method: quantities defining the quality of the effluent to be treated and quantities defining the state of membrane clogging are measured as input variables; the operating point of the microcoagulation process is located on the basis of the results of the above measurements; thresholds for the input variables are determined, the microcoagulation having to be initiated when said thresholds are violated; and the coagulation reactant(s) is(are) injected depending on the results of the measurements and on the comparison of the input variables with the respective thresholds.

The invention relates to a method for the advanced control of a membrane filtration unit, applied to the treatment of any effluent, employing microcoagulation on a membrane according to patent EP 1 239 943, resulting from patent application WO 01/41906, the proprietor of which is the Applicant.

To prevent clogging of microfiltration, ultrafiltration, nanofiltration and hyperfiltration membranes for the treatment of liquids such as, for example, surface water, wastewater or seawater, is a major technical and economic challenge well known to those skilled in the art.

To achieve this objective, the Applicant is the proprietor of Patent EP 1 239 943 which consists in injecting, upstream of the membrane, one or more coagulants with a very low dose, much lower than is the common practice of those skilled in the art, namely 30 to 80 times lower than the optimum jar test dose (coagulation test) making the zeta potential zero. The injection of the coagulant(s) as practiced according to EP 1 239 943 results in a significant reduction in membrane fouling, resulting in an increase in permeability of the membrane, that is to say the rate of effluent flow passing per unit area (m²) of said membrane, for a transmembrane pressure normalized to 1 bar, at a given temperature.

EP 1 239 943 teaches microcoagulation over a dosage range that ensures satisfactory operation without however optimizing the dosage. As a result, for a nonoptimized dosage within said range, the performance of the membrane is inferior to that which it is possible to achieve. Furthermore, in the case of an overdosage of the coagulant within said range, there is an economic overcost and the risk of blocking the membrane.

The object of the present invention is, most particularly, to optimize, in real time, the injected dose of the coagulant or coagulants during implementation of the membrane microcoagulation process defined above, by a method that continuously integrates the variations in the quality of the effluent and/or in the backflows and by an installation for implementing this method.

The aim of the invention is to achieve these objectives so as to obtain, in real time, almost optimum membrane performance automatically, avoiding or eliminating any human intervention. To do this, the present invention relates to an optimized, reliable and safe method of controlling a membrane filtration unit.

According to the invention, a method for the advanced control of a filtration unit, applied to the treatment of any effluent, employing microcoagulation on a membrane, consists in injecting, upstream of the membrane, a dose of coagulant(s) 30 to 80 times smaller than the dose giving the effluent a zero zeta potential, and is characterized in that:
as input variables, quantities defining the quality of the effluent to be treated and quantities defining the membrane fouling state are measured;
the operating point of the microcoagulation process is located on the basis of the results of the above measurements and thresholds for the input variables, the microcoagulation having to be triggered when these are violated, are determined; and
depending on the results of the measurements and the comparison of the input variables with the respective thresholds, the coagulant or coagulants are injected.

Preferably, the measured quantities for defining the quality of the effluent to be treated comprise at least one of the following quantities:
the temperature;
the content of organic matter, in particular TOC and/or UV absorbance and/or fouling index measurements; and
the content of suspended and/or colloidal matter, in particular turbidity and/or zeta potential and/or particle counting measurements.

The measured quantities for defining the membrane fouling state advantageously comprise at least the following quantities:
the instantaneous flow rate Q_{EB} of the effluent treated on the membrane stage;
the injection flow rate Q_{R} of the coagulant or coagulants; and
the transmembrane pressure P_{TM}.

Preferably, the operating point is located by determining the coagulant suitable for the measured effluent and by determining the range of variation of the dose of coagulant.

The operating point may be located on the basis of a parameterization table for making the suitable coagulants and appropriate dosing ranges correspond to types of effluents defined by ranges of characteristic quantity values.

The operating point may be determined by an expert system that selects the coagulant(s) appropriate to the measured effluent and from this determines, by modeling, the range of dosage variation for tending toward the optimum operating point.

The coagulant dosage may be regulated by being slaved to the treated effluent flow rate.

Advantageously, the coagulant may be dosed by regulation with injection of a minimum dose and stepwise increase in the dose for as long a time as the increase in the dose produces an increase in the membrane permeability, the increase in injected coagulant dose being stopped when a reduction in membrane permeability results from an increase in the dose.

The injection of the coagulant(s) may be regulated according to the operating backflows of the membrane, signifying the fouling thereof, in order to tend toward the optimum operating point.

When there is doubt about the validity or the representativeness of one of the input signals or when an anomaly in the backflows occurs, the membrane unit may be controlled according to a station feedback control mode. The feedback control mode is a control by feedback with a fixed degree of treatment. As a variant, the feedback control mode is one in which the implementation of said invention is stopped.

Advantageously, the membrane operating parameters are adapted according to the setpoints, with the aim of eliminating/monitoring/controlling the accumulation of matter in the vicinity of the membrane. The preferentially adjusted operating parameters are: the procedure, duration and frequency of the backwashings and washings, and the choice of associated coagulants. Thus, for example, pulsed two-phase backwashings as described by FR 2 867 394, the proprietor of which is the Applicant, could advantageously be employed. Likewise, the nature of the washing coagulant(s) will be selected for its oxidizing or chelating or acid-base properties, for example to promote the elimination of the coagulant(s) employed according to the present invention.

It is also possible to adapt, according to the setpoints, the operating parameters of the treatment plant, especially the control of the discharges containing the coagulant(s). This is because the presence of coagulant(s) in the membrane washing waters, caused by implementing the present invention, may be problematic as regards direct discharge into the environment or recycling in the treatment plant. In this case, it may be necessary to start up a specific plant for treating these washing waters. These treatments are known to those skilled in the art, for example settling or flotation or centrifugation or filtration techniques carried out over a medium, over a mesh, over a cloth or over a membrane.

The invention also relates to an installation for implementing the method, comprising at least one membrane filtration unit, applied to the treatment of an effluent, employing microcoagulation on a membrane, comprising means for injecting, upstream of the membrane, a dose of coagulant(s) 30 to 80 times lower than the dose giving the effluent a zero zeta potential, characterized in that it includes a control assembly comprising:
means for measuring, as input variables, quantities defining the quality of the effluent to be treated and quantities defining the membrane fouling state;
a unit for locating the operating point of the microcoagulation process on the basis of the results of the above measurements and for determining thresholds for the input variables, the microcoagulation having to be triggered when said thresholds are violated;
a module for analyzing the measurement results and for comparing the input variables with the respective thresholds; and
a module for injecting the coagulant(s).

The unit may comprise a block assigned to the process input variables and a block to which information about input quantities specific to the membrane or membranes used, namely membrane/backflow operating data, is sent.

The block assigned to the input variables receives information delivered by the measurement of quantities characteristic of the quality of the effluent upstream of the membrane, comprising at least one of the following quantities:
the temperature of the effluent, delivered by a sensor;
the content of organic matter of the effluent, delivered by a sensor, by TOC (total organic carbon) and/or UV absorbance and/or fouling index measurements;
the content of suspended and/or colloidal matter, delivered by a sensor, by turbidity and/or zeta potential and/or particle counting measurements,
the sensors being placed in the effluent intake line.

The block, to which information about input quantities specific to the membrane(s) used is sent, receives information delivered by the measurement of quantities characteristic of the state of the membrane, comprising at least the following quantities:
the instantaneous flow rate (Q_{EB}) of the effluent treated on the membrane stage, delivered by a flowmeter installed on the intake line of the effluent to be treated;
the injection flow rate (Q_{R}) of the coagulant(s), delivered by a flowmeter installed on the coagulant injection line; and
the transmembrane pressure P_{TM} (in bar) delivered by two pressure sensors placed on either side of the membrane.

The installation may include input means for allowing the user to input setpoints/thresholds of the variables in order to define the field of application of the membrane microcoagulation relative to the nature and the quality of the effluent and to the membrane technology.

Preferably, the module for locating, on the basis of the setpoints and the input variables, the operating point of the membrane microcoagulation process is provided for processing the information:
either by a block in which a parameterization table, for parameterizing according to the quality of the effluent, is stored, which block makes it possible, according to the effluent data delivered, to deliver the setpoints as regards the preferential use of a/the coagulant(s) and with regard to the optimum dosage range for this or these coagulants;
or by a block comprising an expert system having computing means and software for modeling, by expertise rules, the curve for making the zeta potential zero as a function of the dose of the coagulant(s) and for thus defining, for a coagulant or a mixture of coagulants, the variables X, then X/30 and X/80.

Advantageously, the control assembly includes a module for controlling the rate of injection of the coagulant or coagulants according to the informed requirements. The control module is made up of two control logic blocks that are activated, depending on the information availability, in order to control the equipment for injecting the coagulant(s), namely:
one control logic block being designed to ensure operation of the coagulant injection in feedback mode; and
the other control logic block being designed to ensure operation of the coagulant injection in regulating mode.

The invention consists, apart from the abovementioned arrangements, of a number of other arrangements, which will be more explicitly addressed below as regards illustrative examples described with reference to the appended drawings, although these are in no way limiting. In these drawings:

FIG. 1 is a diagram of an installation for implementing the method according to the invention using an encased circulation-type membrane;

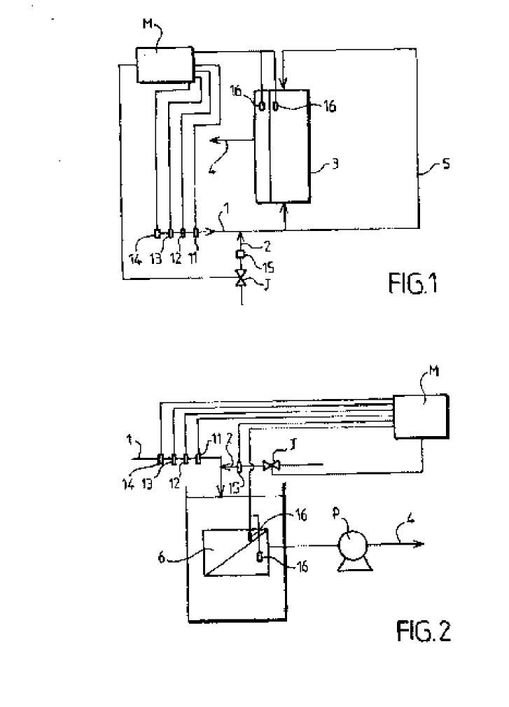

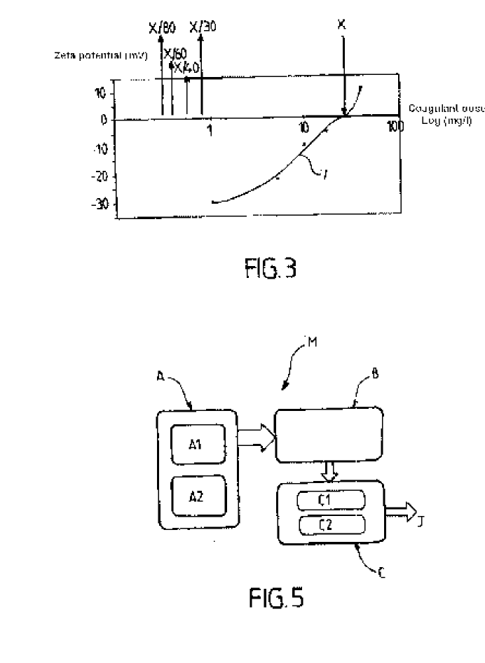

FIG. 2 is a diagram of an installation for implementing the method according to the invention using an immersed free (i.e. unencased) membrane;

FIG. 3 is an example of treatment using a curve for making a given effluent have a zero zeta potential as a function of the dose of a coagulant plotted on the x-axis, on a logarithmic scale, while the zeta potential in millivolts is plotted on the y-axis;

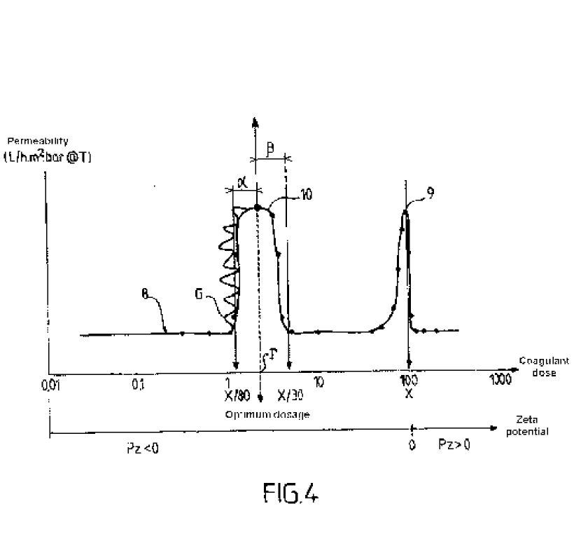

FIG. 4 is a diagram illustrating the variation in permeability of the membrane as a function of the injected coagulant dose for a given effluent;

FIG. 5 is a block diagram of the installation for implementing the method of the invention;

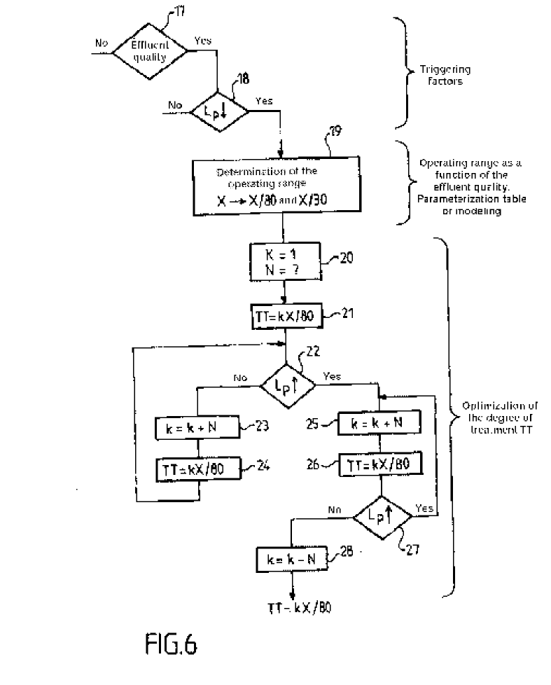

FIG. 6 is a flowchart of the method of the invention;

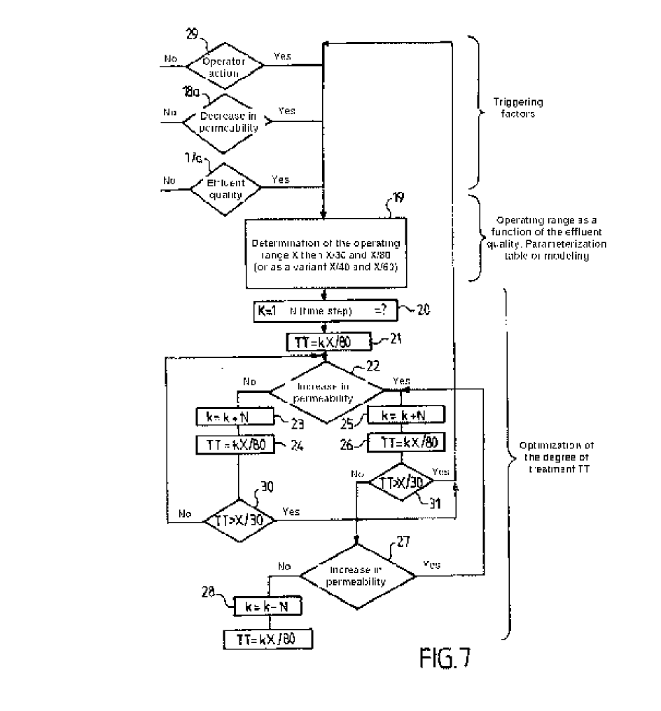

FIG. 7 is an alternative form of the flowchart of FIG. 6; and

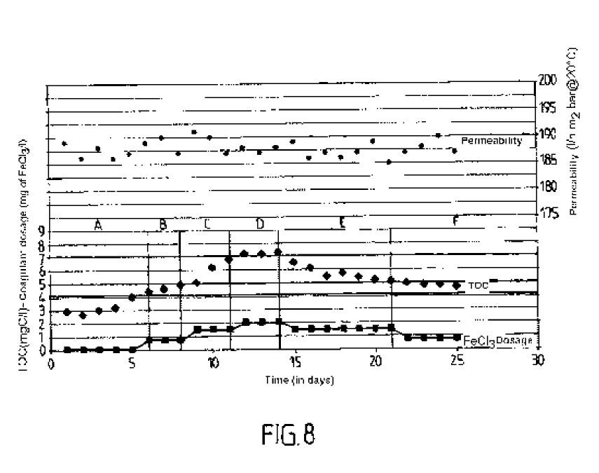

FIG. 8 is a plot illustrating the results of an example of the implementation of the control method of the invention.

In FIG. 1 may be seen an installation for filtering water 1 to be treated, in which a coagulant is injected at 2, upstream of the encased filtration membrane 3. The water to be treated/coagulant mixture is filtered over the encased membrane 3 and the treated water leaves via a line 4. The installation may include a recirculation loop 5.

In the installation shown in FIG. 2, the water 1 to be treated/coagulant 2 mixture is filtered over a free membrane 6 immersed in a basin containing the water to be treated. The treated water 4 is discharged using a pump P.

FIG. 3 is an example of treatment using a curve 7 for making a given effluent have a zero zeta potential as a function of the dose of a coagulant, which is plotted on a logarithmic scale on the x-axis, the dose being expressed in mg/L (milligrams per liter). The zeta potential is plotted on the y-axis and is expressed in mV (millivolts).

The point of intersection of curve 7 with the x-axis corresponds to the coagulant dose X that makes the zeta potential zero.

This dose X is plotted on the x-axis in FIG. 4, which shows the variation in permeability (in l/h·m²·bar@T (liters/hour·m²·bar@T)) of a membrane. The permeability is plotted on the y-axis, while the coagulant dose is plotted on the x-axis with a logarithmic scale. Appearing beneath the coagulant dose axis is a horizontal axis corresponding to the zeta potential. Curve 8 illustrates the variation in permeability of the membrane as a function of the dose of coagulant injected upstream of this membrane.

Conventionally, for the coagulant dose equal to X that makes the zeta potential zero, the permeability of the membrane increases strongly at a peak 9 which is relatively narrow along a direction parallel to the x-axis.

As patent EP 1 239 943 teaches, the permeability of the membrane shows, completely surprisingly, a strong increase, illustrated by a jump 10 in curve 8, for a coagulant dose of between X/80 and X/30. It is thus apparent that, with a well-chosen reduced coagulant dose, it is possible to obtain an improvement in the membrane permeability equivalent to or greater than that obtained when the zeta potential is zero.

In FIG. 4, the symbol Γ denotes (on the x-axis) the dosage corresponding to the top of the jump 10 that corresponds to the optimum technical and economic operating point since this dosage maximizes the permeability with a minimum consumption of coagulant.

The region to the right of the point Γ and bounded by the value X/30 is denoted by β. This region corresponds to a coagulant overdosage relative to the optimum operating point Γ, but with no improvement in membrane performance or even a deterioration thereof. Operating in the region β furthermore runs the risk of matter and coagulant accumulating in the vicinity of the membrane, with a risk of blocking it for certain membrane geometries.

The region lying between the point Γ and the lower limit X/80 is denoted by α. This region corresponds to an underdosage relative to the optimum operating point Γ with inferior membrane performance.

FIG. 3 shows schematically the coagulant dose limits X/30 and X/80 with a preferred intermediate range from X/60 to X/40.

FIG. 4 explains the main purpose of the invention, which consists in providing a membrane filtration operating point close to the optimum Γ. If the operating point corresponds to a coagulant dose below that of the point Γ, the efficiency of the membrane is not optimum. If the coagulant dose is above that of the point Γ, not only is the efficiency lower but this results in a higher economic cost because of the overdosing and a risk of blocking in certain membrane geometries.

One difficulty in operating close to the optimum point Γ lies in the risk of the operation diverging toward the limits of the range.

The method of the invention is based on the following logic:
cognizance, for injecting the coagulant, of triggering factors formed by characteristics defining the quality of the effluent and/or operating backflows, i.e. characteristics defining the state of the membrane;
identification of the X/30-X/80 operating range on the basis of the quality of the effluent; and
optimization of the injected coagulant dose over the operating range so as to lie close to the point Γ, with a coagulant dose that nevertheless remains below that of the point Γ, and/or with no risk of divergence toward the extremes of the X/80-X/30 range.

The method of the invention is implemented by a control assembly M (FIGS. 1, 2 and 5) comprising a first unit A that receives input variables (analog data) of two types, namely process input variables and membrane-specific input variables.

The unit A comprises a block A1 assigned to the process input variables. The block A1 receives information delivered by sensors for measuring quantities characteristic of the effluent quality upstream of the membrane, said sensors being installed for example in the effluent intake line, said quantities being:
the temperature of the effluent, delivered for example by a sensor 11 (FIGS. 1 and 2);
the organic matter content of the effluent, delivered for example by a sensor 12: a measure of the TOC (total organic carbon) and/or the UV absorbance and/or the fouling index; and
the content of suspended and/or colloidal matter, delivered for example by a sensor 13, by turbidity and/or zeta potential and/or particle counting measurements.

Of course, the method of the invention is not limited to the analytical techniques mentioned above, by way of example, for the acquisition of the process input variables.

The unit A includes another block A2 to which information about input parameters specific to the membrane(s) used is sent, namely membrane operating/backflow data. These input variables comprise at least the following quantities:
the instantaneous flowrate Q_{EB} (in m³/h) of the effluent treated on the membrane stage, for example delivered by a flowmeter 14 installed on the intake line of the effluent to be treated;
the rate of injection Q_{R} (in m³/h) of the coagulant(s), delivered for example by a flowmeter 15 installed on the coagulant injection line; and
the transmembrane pressure P_{TM} (in bar), delivered for example by two pressure sensors 16 placed on either side of the membrane.

Of course, the invention is not limited to the data delivered by these examples.

As a variant, for spiral modules or what are called IN/OUT internal-skin hollow-fiber membrane modules, a measurement of the pressure drop across the module(s) will be included for example.

Setpoints/thresholds for the variables of the block A1 are input by the operator using inputting means, especially a console (not shown), in order to define the range of application of the membrane microcoagulation relative to the nature and the quality of the effluent and to the membrane technology.

The input variables of the block A1 faced with these setpoints/thresholds constitute factors triggering the use of membrane microcoagulation when the setpoints are violated.

The backflow of the installation, that is to say indicating the state of membrane fouling, estimated from the variables delivered to the block A2, is a potential second factor triggering the use of membrane microcoagulation. Thus, a reduction in permeability below a set limit threshold according to the invention and/or a significant decrease over a set time interval constitute other factors triggering the use of microcoagulation.

The triggering factors may arise in parallel, in which case the microcoagulation is triggered by one or other of the triggering factors, or may arise in series, in which case the microcoagulation is triggered when all the triggering factors indicate that the respective setpoints have been violated.

The control thus described of the factors triggering the membrane microcoagulation provides, according to the invention, the relevance of implementing the method.

The control assembly M includes a module B which makes it possible to locate, on the basis of the setpoints and input variables of the module A, the operating point of the membrane microcoagulation process in an operating space considered as a space for stable and optimum implementation of said method.

Specifically, the module B is used to select the most suitable coagulant(s) and to determine the restricted range of variation of coagulant dose or the degree of treatment according to EP 1 239 943, i.e. a dosage between X/30 and X/80 or, advantageously, between X/40 and X/60, X being the optimum jar test dose giving the effluent to be treated a zero zeta potential.

The various possible coagulants, according to the various types of effluent quality, are stored in separate containers (not shown) that may be brought into communication with the injection line 2 via valves (not shown) controlled by the module B.

Depending on the mode of operation and the availability of the information sources coming from the block A1, the treatment in the module B will be provided:
either by a block B1 in which a parameterization table, for parameterizing the quality of the effluent, is stored, which makes it possible, according to the data delivered by the block A1 relating to the effluent, to deliver the setpoints for the preferential use of one or more coagulants and over the optimum dosage range for this or these coagulants; this dosage range preferably corresponds to a reduced range, lying within the region α shown in FIG. 4, for dosages slightly below that of the point Γ;
or, according to another possibility, the information coming from the block A1 and input into the module B is processed in a block B2 comprising an expert system having computing means and software. The block B2, on the basis of the A1 inputs, models, by expertise rules, the curve making the zeta potential zero as a function of the coagulant dose and thus defines, for one coagulant or a mixture of coagulants, the variables X, then X/30 and X/80 or, as a variant, X/60 and X/40 as illustrated in FIG. 3.

Depending on the quality of the effluent, continuously measured by sensors, the determination of the optimum dosage range X/30-X/80, or as a variant X/40-X/60, is thus automatically updated.

The assembly M further includes a module C which is a control block for controlling the rate of injection of the coagulant or coagulants according to the requirements provided by the module B. Advantageously, the module C controls a valve J (FIGS. 1 and 2) placed in the intake line for the coagulant 2.

The coagulant dose or degree of treatment is defined by:

TT=C_{R}Q_{R}/Q_{EB}

where:
C_{R}=concentration of the coagulant or coagulants;
Q_{R}=coagulant injection flowrate;
Q_{EB}=instantaneous flowrate of the effluent entering the membrane stage.

The module C is designed to optimize the injected coagulant dose and is made up of two control logic blocks C1 and C2 activated, depending on the availability of the information, for controlling the coagulant injection equipment.

The logic control block C1 controls the coagulant injection operation according to a feedback control mode. The objective of the control logic is to maintain a degree of treatment TT with coagulant around a fixed setpoint lying within the region α (FIG. 4) as close as possible to the point Γ. More generally, the setpoint is between X/30 and X/80 or, as a variant, between X/40 and X/60. There is no control of the action exerted, this is thus a pure feedback control mode. Its advantage lies in adapting the coagulant injection flow rate to the operation conditions of the membrane filtration unit, i.e. mainly the flow rate Q_{EB}.

This feedback control mode enables a degree of treatment with coagulant(s) to be maintained over the restricted range of variation around the setpoint value.

The advantage of this variant is that the membrane operates in a stable manner, the coagulant dose being fixed for a given effluent quality.

The module C includes another block C2 with control logic for operating in a regulating mode. The objective of this logic is to maintain a degree of coagulant treatment TT so as to continuously guarantee an optimum degree of treatment close to the point Γ according to FIG. 4. The membrane permeability measurements and the pressure drop measurements of the filtration module (in the case of internal-skin hollow-fiber modules and spiraled modules) are used here to control and regulate the rate of injection of the coagulant mixture(s).

To do this, as illustrated in FIG. 4 by the sinuous rising curve G, the initially injected coagulant dose corresponds to X/80 or, as a variant, X/60, so as to definitely locate the operating point upstream of the ascending portion of the jump 10, while still remaining in the region α.

The regulating block C2 progressively increases, stepwise, the rate of injection of the coagulant(s) for as long as:
the variation in permeability is positive, greater than a given setpoint, over a fixed time interval; and
the variation in the measured pressure drop across the membrane remains below a setpoint over a fixed time interval.

As soon as the variation in permeability is negative, which corresponds to violation of the point Γ, or as soon as the variation in the measured pressure drop across the membrane becomes greater than the setpoint, the regulating block C2 ceases to increase the rate of coagulant injection.

The advantage of this solution lies in the membrane fouling being continuously analyzed and the resulting degree of treatment being continuously adapted. Moreover, this regulating mode allows the operation to tend toward or converge on the operating point Γ which is technically optimum (maximum improvement in membrane performance) and economically optimum since a higher dosage than that of the point Γ does not improve the membrane performance (region β) and increases the risk of membrane blockage.

Finally, this control mode makes it possible to be sure that there is no risk of the regulating system diverging, by tending toward the extremes of the X/80-X/30 or, as a variant, the X/60-X/40, operating region.

This control mode makes it possible for the membrane microcoagulation process to be implemented optimally and perfectly safely.

FIG. 6 is a flowchart illustrating the logic employed in the block C.

This flowchart starts, at the top of the chart, with a conditional step 17 that corresponds to verifying the quality of the effluent. The question posed in step 17 corresponds to “is the effluent quality insufficient?”. The effluent quality is verified in step 17 according to the abovementioned criteria.

If the answer is “NO”, there is no need for microcoagulation. If the answer is “YES”, it is possible, as illustrated in FIG. 6, to subordinate the triggering of the microcoagulation to a new conditional step 18 for verifying whether the membrane permeability is in the process of decreasing.

If the answer to the question in step 18 is “NO”, that is to say if the permeability is not decreasing, microcoagulation is not triggered. However, if the answer is “YES”, meaning that the membrane permeability is decreasing, the flowchart passes to the next step 19, which determines the coagulant dosage range between X/80 and X/30, X being the dose for making the zeta potential zero.

After step 19, the procedure passes to step 20, which sets the initial value of a factor k applied to X/80 equal to 1 and determines the dosage step N, i.e. the increment in the coagulant dose at each loop.

The next step 21 corresponds to a degree of treatment TT with injection of a coagulant dose kX/80, where k is equal to 1 for the first injection.

The next step 22 verifies whether the membrane permeability increases after the injection carried out at 21. If the answer is “NO”, the factor k is increased by the step N and a dose equal to kX/80 is injected. The increase in the factor k takes place in step 23, and the injection of the increased dose takes place in step 24.

After the injection at step 24, the procedure returns to the question posed in step 22. If the answer to the question at step 22 is “YES”, indicating that the permeability is increasing, at the next step 25 the factor k is increased by the step N and the increased dose kX/80 is injected at step 26.

After the injection at step 26, it is verified in a step 27 whether the membrane permeability is increasing. If the answer is “YES”, the procedure returns to the input to step 25 in order to increase the factor k by a step N so as to rise up the ascending part G of the peak 10 shown in FIG. 4.

When the answer to the question at step 27 is “NO”, the procedure passes to step 28, which gives the value k a value equal to the last value of k reduced by N, i.e. (k−N), which determines the optimum dose kX/80 located close to the maximum of curve 10 shown in FIG. 4.

Steps 17 and 18 correspond to factors triggering the microcoagulation. Step 19 determines the operating range according to the effluent quality by a parameterization table or by modeling.

The next steps 21 to 28 ensure that the degree of treatment TT is optimized.

FIG. 7 illustrates an alternative form of the flowchart shown in FIG. 6. A number of steps are the same, these being denoted by the same numerical references without them being described again.

At the start of the flowchart, there are three conditional steps, 17a, 18a and 29 occurring in parallel. It is sufficient for the answer to one of these questions to be “YES” in order for the next step 19 to be triggered.

Step 17a poses a question about the effluent quality, namely “is the quality insufficient?”. If the answer is “YES”, step 19 is triggered whereas if the answer is “NO” there is no need to trigger the microcoagulation.

Step 18a corresponds to a question about the variation in permeability. If the membrane permeability is decreasing (answer “YES”), step 19 is triggered.

Finally, step 29 corresponds to an action by the user, the latter being able to trigger the microcoagulation.

Unlike FIG. 6, it may be noted that, after step 24, a conditional step 30 is provided for verifying whether the degree of treatment TT is greater than X/30. If the answer is “NO”, the injected dose may be increased further by a step N and the procedure returns to step 22. If the answer is “YES”, the maximum dosage range is violated and the procedure returns to step 19 in order to verify and determine once again the operating range.

The output of step 26 is connected to the input of a conditional step 31 that also verifies whether TT is greater than X/30. If the answer is “YES”, the procedure returns to step 19 in order to determine anew the operating range. If the answer at step 31 is “NO”, the procedure passes to step 27 that verifies whether the membrane permeability is increasing. If the answer is “YES”, the procedure returns to step 25 in order to increase the coagulant dose by a step N. If the answer is “NO”, the procedure passes to step 28, which sets the value of k to the last value k reduced by a step N.

FIG. 8 illustrates, for an example of how the control method of the invention is implemented, the variation in the effluent quality, in the coagulant dosage and in the membrane permeability over the course of time.

This example relates to an experiment carried out on an ultrafiltration membrane module from the French company Aquasource (encased in/out-type, or internal-skin, hollow-fiber membrane), the filtration area of which is 1 m².

A control unit is fitted, in the feed line:
with a temperature sensor;
with an apparatus for in-line measurement of the TOC (total organic carbon);
with a feedwater flowmeter; and
with two pressure sensors based on either side of the membrane in order to measure the transmembrane pressure.

The unit is fed with Seine river water, the quality of which is well known from experiments. In this context, a parameterization table was stored in the block B1 in order to provide the setpoints for preferential use of a coagulant and the optimum dosage range, i.e. close to the optimum dosage Γ as described in the present invention.

This parameterization table indicates, in this specific case, the choice of a single coagulant (ferric chloride) and the degrees of treatment to be carried out as a function of the TOC content of the effluent:

Parameterization Table

| Effluent quality (TOC) | Coagulant | Dosage (mg/l of pure FeCl₃) |
|---|---|---|
| ≦4 mgC/l | FeCl₃ | 0 |
| >4 mgC/l & ≦5 mgC/l | | 0.75 |
| >5 mgC/l & ≦7 mgC/l | | 1.50 |
| >7 mgC/l | | 2.00 |

It should be emphasized that the coagulant dosages provided in this parameterization table are always between X/30 and X/80, where X is the dose of said coagulant that makes the zeta potential zero.

The unit was thus operated over a period of 25 days with a logic for controlling the coagulant injection in a feedback control mode as described in the present invention.

Thus, depending on the feed flow rate, the rate of coagulant injection is slaved to the feed flow rate in order to obtain the coagulant dosage provided in the above table.

The results obtained are illustrated in FIG. 8, in which:
the time, expressed in days, is plotted on the x-axis;
the TOC contents of the effluent to the filtered in mg C per liter and the coagulant dosage in mg per liter of pure FeCl₃ are plotted on the left-hand y-axis; and
the membrane permeability in l/h·m²·bar@20° C. is plotted on the right-hand y-axis.

Over the course of the trial period, six separate periods (A, B, C, D, E and F) are thus distinguished during which the ferric chloride dosage is adjusted between 0 and 2 mg/l of pure product according to the variation in TOC content of the effluent as per the parameterization table given above.

During period A:
coagulant injection is not activated (TOC 4 mgC/l);
the membrane is operated in dead-end (direct flow) filtration with 30 seconds of backwashing with water every 90 minutes without coagulant injection; and
the washing waters are discharged into a drain without treatment.

During periods B, C, E, F and G:
coagulant injection is activated and the dosage slaved to the feed flow rate in order to comply with a dosage in accordance with the parameterization table depending on the effluent quality (TOC concentration);
the membrane is operated in dead-end filtration mode, this time with pulsed air/water backwashing for 40 seconds every 60 minutes. This air/water backwashing is in fact more effective for removing the coagulant which could accumulate in the vicinity of the membrane. Moreover, every twelve backwashings, the counter-permeation injected permeate contains 1 g/l of citric acid in order to dissolve the iron hydroxides and promote coagulant elimination; and
finally, the washing waters containing iron hydroxides are automatically directed toward a settling tank, the supernatant of which is discharged into the drain and the sludge extracted so that the quality of the discharges into the drain is not affected by implementing the microcoagulation.

During period D, the operating conditions are similar to periods B, C, E, F and G. However, because of the increase in the coagulant dosage above the 1.5 mg/l of pure FeCl₃ threshold, the two-phase backwashing frequency is increased, i.e. a backwashing every 45 minutes, and the frequency of acid injection is increased to once every 6 backwashings.

Throughout the trial period, the variation in the treatment operation is automatically controlled without human intervention. This entirely automated control method according to the present invention enables the microcoagulation to be implemented under optimum conditions that are adapted according to the variation in effluent quality.

Thus, throughout the 25-day experiment, the operation of the membrane remained stable (permeability between 185 and 195 l/h·m²·bar@20° C.) illustrating the control in implementing the microcoagulation provided by the advanced control method described by the present invention.

1. A method for the advanced control of a membrane filtration unit, applied to the treatment of an effluent, employing microcoagulation on a membrane, which consists in injecting, upstream of the membrane, a dose of coagulant(s) 30 to 80 times smaller than the dose (X) giving the effluent a zero zeta potential, wherein:
as input variables, quantities defining the quality of the effluent to be treated and quantities defining the membrane fouling state are measured;
the operating point of the microcoagulation process is located on the basis of the results of the above measurements and thresholds for the input variables, the microcoagulation having to be triggered when these are violated, are determined; and
depending on the results of the measurements and the comparison of the input variables with the respective thresholds, the coagulant or coagulants are injected.

2. The method as claimed in claim 1, wherein the measured quantities for defining the quality of the effluent to be treated comprise at least one of the following quantities:
the temperature;
the content of organic matter, in particular TOC and/or UV absorbance and/or fouling index measurements; and
the content of suspended and/or colloidal matter, in particular turbidity and/or zeta potential and/or particle counting measurements.

3. The method as claimed in claim 1, wherein the measured quantities for defining the membrane fouling state comprise at least the following quantities:
the instantaneous flow rate Q_{EB} of the effluent treated on the membrane stage;
the injection flow rate Q_{R} of the coagulant or coagulants; and
the transmembrane pressure P_{TM}.

4. The method as claimed in claim 1, wherein the operating point is located by determining the coagulant(s) suitable for the measured effluent and by determining the range of variation of the dose of the coagulant(s).

5. The method as claimed in claim 1, wherein the operating point is located on the basis of a parameterization table for making the suitable coagulants and appropriate dosing ranges correspond to types of effluents defined by ranges of characteristic quantity values.

6. The method as claimed in claim 1, wherein the operating point is determined by an expert system that selects the coagulant(s) appropriate to the measured effluent and from this determines, by modeling, the range of dosage variation for tending toward the optimum operating point.

7. The method as claimed in claim 1, wherein the coagulant dosage is regulated by being slaved to the treated effluent flow rate.

8. The method as claimed in claim 1, wherein the coagulant is dosed by regulation with injection of a minimum dose and stepwise increase in the dose for as long a time as the increase in the dose produces an increase in the membrane permeability, the increase in injected coagulant dose being stopped when a reduction in membrane permeability results from an increase in the dose.

9. The method as claimed in claim 8, wherein the injection of the coagulant(s) is regulated according to the operating backflows of the membrane, signifying the fouling thereof, in order to tend toward the optimum operating point.

10. The method as claimed in claim 1, wherein, when there is doubt about the validity or the representativeness of one of the input signals or when an anomaly in the backflows occurs, the membrane unit is controlled according to a station feedback control mode.

11. An installation for implementing a method as claimed in claim 1, comprising at least one membrane filtration unit, applied to the treatment of an effluent, employing microcoagulation on a membrane, comprising means (2) for injecting, upstream of the membrane, a dose of coagulant(s) 30 to 80 times lower than the dose (X) giving the effluent a zero zeta potential, wherein it includes a control assembly (M) comprising:
means (11, 12, 13; 16) for measuring, as input variables, quantities defining the quality of the effluent to be treated and quantities defining the membrane fouling state;
a unit (A) for locating the operating point of the microcoagulation process on the basis of the results of the above measurements and for determining thresholds for the input variables, the microcoagulation having to be triggered when said thresholds are violated;
a module (B) for analyzing the measurement results and for comparing the input variables with the respective thresholds; and
a module (C) for injecting the coagulant(s).

12. The installation as claimed in claim 11, wherein the unit (A) comprises a block (A1) assigned to the process input variables and a block (A2) to which information about input quantities specific to the membrane or membranes used, namely membrane/backflow operating data, is sent.

13. The installation as claimed in claim 12, wherein the block (A1) assigned to the input variables receives information delivered by the measurement of quantities characteristic of the quality of the effluent upstream of the membrane, comprising at least one of the following quantities:
the temperature of the effluent, delivered by a sensor (11);
the content of organic matter of the effluent, delivered by a sensor (12), by TOC (total organic carbon) and/or UV absorbance and/or fouling index measurements;
the content of suspended and/or colloidal matter, delivered by a sensor (13), by turbidity and/or zeta potential and/or particle counting measurements,
the sensors being placed in the effluent intake line.

14. The installation as claimed in claim 12, wherein the block (A2), to which information about input quantities specific to the membrane(s) used is sent, receives information delivered by the measurement of quantities characteristic of the state of the membrane, comprising at least the following quantities:
the instantaneous flow rate (Q_{EB}) of the effluent treated on the membrane stage, delivered by a flowmeter (14) installed on the treated effluent intake line;
the injection flow rate (Q_{R}) of the coagulant(s), delivered by a flowmeter (15) installed on the coagulant injection line; and
the transmembrane pressure P_{TM} (in bar) delivered by two pressure sensors (16) placed on either side of the membrane.

15. The installation as claimed in claim 11, wherein it includes input means for allowing the user to input setpoints/thresholds of the variables in order to define the field of application of the membrane microcoagulation relative to the nature and the quality of the effluent.

16. The installation as claimed in claim 11, wherein the module (B) for locating, on the basis of the setpoints and the input variables, the operating point of the membrane microcoagulation process is provided for processing the information:
either by a block (B1) in which a parameterization table, for parameterizing according to the quality of the effluent, is stored, which block makes it possible, according to the effluent data delivered, to deliver the setpoints as regards the preferential use of a/the coagulant(s) and with regard to the optimum dosage range for this or these coagulants;
or by a block (B2) comprising an expert system having computing means and software for modeling, by expertise rules, the curve for making the zeta potential zero as a function of the dose of the coagulant(s) and for thus defining, for a coagulant or a mixture of coagulants, the variables X, then X/30 and X/80.

17. The installation as claimed claim 11, wherein the control assembly (M) furthermore includes a module (C) for controlling the rate of injection of the coagulant or coagulants according to the informed requirements.

18. The installation as claimed in claim 17, wherein the control module (C) is made up of two control logic blocks (C1, C2) that are activated, depending on the information availability, in order to control the equipment for injecting the coagulant(s), namely:
one control logic block (C1) being designed to ensure operation of the coagulant injection in feedback mode; and
the other control logic block (C2) being designed to ensure operation of the coagulant injection in regulating mode.
